(19) United States
(12) Patent Application Publication
(10) Pub. No.: US 2026/0147751 A1
(43) Pub. Date: May 28, 2026

(54) UPDATING IT OPERATIONS MANAGEMENT PLATFORM DATA AT SCALE

(71) Applicant: The PNC Financial Services Group, Inc., Pittsburgh, PA (US)

(72) Inventor: Jason L. Miller, Chandler, AZ (US)

(21) Appl. No.: 19/387,800

(22) Filed: Nov. 13, 2025

Related U.S. Application Data
(60) Provisional application No. 63/726,011, filed on Nov. 27, 2024.

(51) Int. Cl. G06F 16/23; G06F 16/28

(52) U.S. Cl. CPC G06F 16/2379; G06F 16/2365; G06F 16/288

(57) ABSTRACT

Computer-implemented methods and system update an active database with ITOM data by: (a) loading ITOM data, collected by an ITOM platform, from a cloud storage bucking to a first (staging) database; (b) loading the ITOM data from the first (staging) database to a second (raw) database; (c) determining, by an engine running on a server, whether data in the active database should be updated with data from the second (raw) database; and (d) repeating steps (a)-(c) according to a schedule.

### PRIORITY CLAIM

The present application claims priority to U.S. provisional patent application Ser. No. 63/726,011, filed Nov. 27, 2024, titled “Updating Operations Management Platform Data at Scale.”

### CROSS-REFERENCE TO RELATED APPLICATIONS

The present application is related to, and incorporates herein by reference, (i) U.S. provisional patent application Ser. No. 63/712,086, filed Oct. 25, 2024, titled “Configuring an IT Monitoring System,” and (ii) U.S. patent application Ser. No. 19/322,184, filed Sep. 8, 2025, titled “Configuring an IT Monitoring System.”

### BACKGROUND

An IT operations management platform (ITOM), such as BigPanda, helps enterprises detect, investigate, and resolve IT incidents faster. ITOMs help reduce mean time to repair, improve service availability, and enhance overall IT efficiency. Via a variety of data ingestion methods, ITOMs collect massive amounts data from various sources with an enterprise's IT infrastructure, such as log data, metrics, alerts and tickets. Handling this vast amount of data effectively is crucial for ITOM platforms to provide useful insights. Ingesting such vast amounts of data at scale presents challenges that can impact the accuracy, speed, and overall effectiveness of data analysis, especially in large and complex IT environments.

### SUMMARY

In one general aspect, the present invention is directed to computer-implemented systems and methods for updating an active ITOM database with ITOM data at scale. A method according to various embodiments of the present invention can comprises: (a) loading ITOM data, collected by an ITOM platform, from a cloud storage bucking to a first (staging) database; (b) loading the ITOM data from the first (staging) database to a second (raw) database; (c) determining, by an engine running on a server, whether data in the active database should be updated with data from the second (raw) database; and (d) repeating steps (a)-(c) according to a schedule. Step (c) can comprise determining whether a first key for a first key-value pair in the second (raw) database is present in the active database; and upon a determination that the first key is not present in the active database, adding the first key-value pair to the active database. For a second key-value pair, step (c) can comprise determining whether a second key for the second key-value pair in the second (raw) database is present in the active database; and upon a determination that the second key is present in the active database, and upon a determination that a timestamp for the second key-value pair in the second (raw) database is greater than a timestamp for the second key-value pair in the active database, updating the second key-value pair in the active database with a timestamp for the second key-value pair in the second (raw) database.

A system according to embodiments of the present invention includes an ITOM platform configured to collect ITOM data from enterprise IT infrastructure and to store the ITOM data in a cloud storage bucket. The system can include a plurality of servers, each with at least one processor and memory storing instructions. A first server can be configured with instructions that, when executed, cause a first engine to load the ITOM data from the cloud storage bucket to a staging database of the enterprise and to further load the ITOM data from the staging database to a raw database. One of the plurality of servers can be configured with instructions that, when executed, cause a second engine selected from engines distributed across the plurality of servers and scheduled to run in a non-overlapping manner to determine whether to update an active database with data from the raw database. A task scheduling server can be provided to determine a schedule according to which the collecting, loading, and determining are repeated.

In certain variations, the staging, raw, and active databases can each be implemented as SQL databases. The raw and active databases can store the ITOM data in a key-value format that includes automatically generated update timestamp attributes and offset attributes to resolve conflicts among multiple records. The plurality of engines can be single-threaded engines that execute one job script at a time, with scheduling based on parameters such as a job period, expected runtime, or allowable start times. The servers can be distributed across multiple data centers to provide resiliency and scale. The ITOM data can include incident records, alerts, tags, change records, and other files describing the status of enterprise IT resources. In addition, stale data in the active database can be marked and deleted by a deletion job executed by one of the engines.

Several technical advantages can be realized with these methods and systems. For example, embodiments can improve the freshness and accuracy of ITOM incident data available for operational decision-making. By employing timestamp and offset attributes, update conflicts can be resolved deterministically, ensuring consistency in the active database. Distributing engines across servers and scheduling them in a non-overlapping manner enables high-throughput ingestion while avoiding race conditions and data corruption. Optional deployment across multiple data centers provides improved fault tolerance and scalability. The resulting system allows enterprises to reliably identify and prioritize IT incidents, optimize capacity planning, and document operational responses for compliance and audit purposes. These and other benefits realizable through embodiments of the present invention will be apparent from the description that follows.

### FIGURES

Various embodiments of the present invention are described herein by way of example in connection with the following figures.

FIG. 1 is a diagram showing servers with engines that run jobs, such as processing data from an ITOM, according to various embodiments of the present invention.

FIG. 2 is a diagram of a system architecture comprising an ITOM and data storage locations for storing the data from the ITOM according to various embodiments of the present invention.

FIGS. 3A and 3B collectively show a data schema of an ITOM according to various embodiments of the present invention.

FIG. 4 is process flow diagram of a process performed by an instance of an engine running a job to update the active database of FIG. 2 with active ITOM data from the raw database of FIG. 2 according to various embodiments of the present invention.

FIGS. 5A-5D collectively show an example schema for ITOM tables imported through an ETL process according to various embodiments of the present invention.

### DESCRIPTION

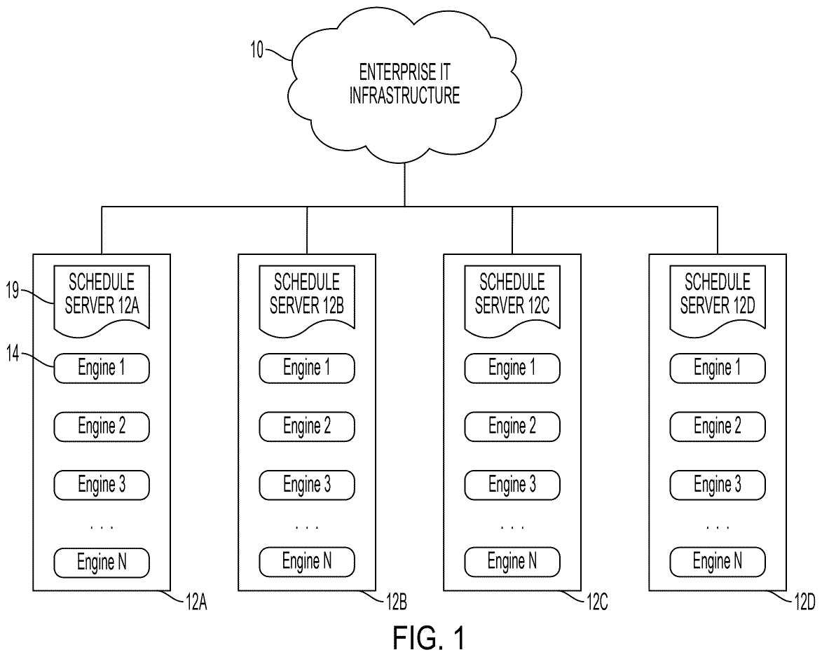

In one general aspect, the present invention is directed to engines that can take turns processing data files from an ITOM, such as BigPanda, for an enterprise so that the vast amount of data collected by the ITOM can be ingested by the enterprise for analysis and resolution of IT incidents. Before describing the innovative manner in which the engines process and ingest the ITOM data, an example environment for the engines is provided. FIG. 1 is a diagram showing a plurality of engines 14 in communication with the enterprise's IT infrastructure 10. FIG. 1 shows the engines 14 being run across multiple servers, in this example, four servers 12A-D. Each server 12A-D includes multiple engines 14. Of course, the servers 12A-D can be considered part of the enterprise's IT infrastructure 10.

Each engine 14 is for performing a job that has one or more sequential steps or tasks. There is a script for each job, such as a Python script or a PowerShell script, for example, and execution of job's script by an engine 14 requires the engine 14 to execute, for example, a job or action with respect to the IT system of the enterprise, such as performing an API call, collecting files from an IT resource, collecting data from a certain IT resource that satisfy specified criteria, etc. One of the tasks that the engines 14 can perform, when scheduled to do so, is process the data from an ITOM, as described further below. The process is referred to herein sometimes as an “ITOM job.”

The multiple servers 12A-D could be distributed across multiple data centers, such as two or more data centers. In the illustrated embodiment, the servers 12A-D all contain the same number (N) of engines 14, although in other embodiments, the servers 12A-D do not need have identical numbers of engines 14. Each of the engines 14 is preferably single threaded so that an engine 14 executes one sequence of operations (or thread) at a time. For example, in such a single-thread engine embodiment, each engine 14 handles only one task, request, or connection at any given moment, processing tasks sequentially rather than concurrently.

The engines 14 can be implemented as sets of instructions that run on the servers' hardware to execute the scripts for the jobs. The software for the engines 14 may use any suitable computer programming language such as Java, Python, PowerShell, Ruby, C #, or C++, for example, using conventional, functional, or object-oriented techniques. Programming languages for computer software and other computer-implemented instructions may be translated into machine language by a compiler or an assembler before execution and/or may be translated directly at run time by an interpreter. Each server 12A-D preferably comprises one or more processors for executing the engines 14, along with memory and storage for storing the scripts that are executed by the engines 14. Each of the processors may comprise multiple cores, such as 8, 16 or 20 processor cores, for example. In some embodiments, each server 12A-D comprises at least as many processor cores as there are engines 14 on the server 12A-D, although that is not a requirement and the server's operating system could use time-sharing or context-switching so that the single-threaded engines can take turns running on the available cores. The servers' computer memories (e.g., RAM) can store the scripts and the data that the engines 14 operate on during execution. When a script is loaded and run, the data it processes (like variables, datasets, or objects) can be held in RAM. If multiple scripts or processes run concurrently, each can have its own portion of memory. The scripts, along with any libraries and dependencies, can be stored on the servers' hard drive or SSD. Such storage can also be used to maintain logs, databases, or other persistent data that the engines 14 might access or generate.

The jobs that the engines 14 are to perform, such ITOM job, may be on a periodic schedule. And different jobs can have different periods depending on the nature of the job. For example, jobs could be scheduled to run every 5, 10, 20, 60, 240, 720, or 1440 minutes, etc., depending on the nature, sensitivity and/or complexity of the job. Some jobs could even have longer or different periods, such as several days. The ITOM job can have a high frequency (e.g., a short period) because the ITOM system can be collecting data from the enterprise's IT system continuously.

A task scheduling server (not shown) may coordinate and determine the schedules for the servers 12A-D based on parameters for the jobs and based on the number of engines 14 on the servers 12A-D. For example, the task scheduling server can receive values for relevant parameters for each job to be performed by the engines 14. The parameters can include, for example, how often the job is to be run (i.e., its period), how long the job is expected to take for an engine 14 to perform, a spread quantifiers (e.g., standard deviation or variance) on the time needed for the job, a no-earlier-than time to start the job on a given day (e.g., 8:00 am), a no-later-than time to start a job on a given day (e.g., 10:00 pm), etc. Based on the parameter values of the various jobs and other factors, such as the number of engines 14 on the servers 12A-D, the task scheduling server computes and distributes a schedule 19 for each of the servers 12A-D. The servers' schedules are ordinarily different because, as described above, they preferably are not scheduled to perform the same jobs at the same time.

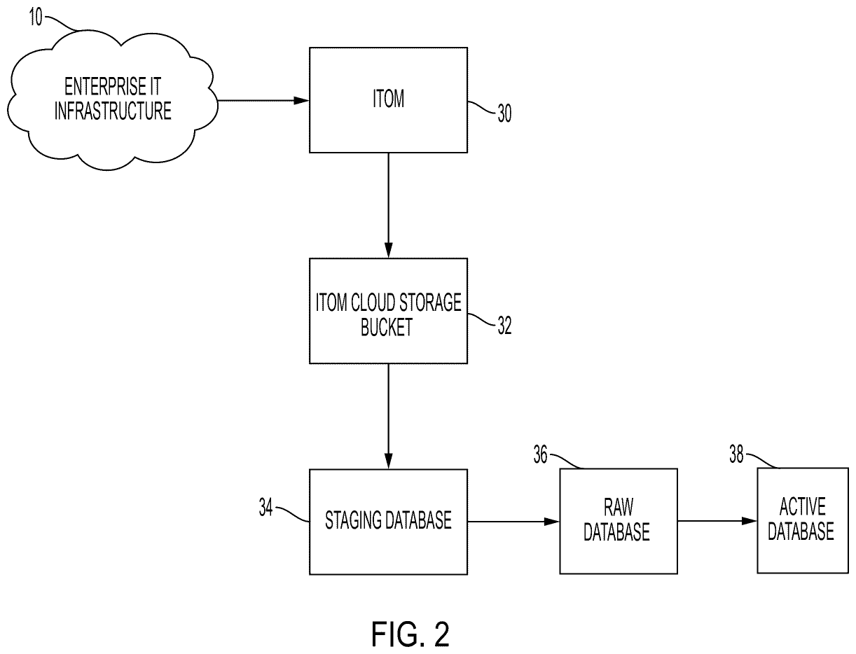

FIG. 2 provides a general overview of the process for the ITOM job. The enterprise's ITOM 30 collects data from various sources with an enterprise's IT infrastructure 10, such as log data, metrics, alerts and tickets, and the ITOM 30 stores the collected data in an ITOM cloud storage bucket 32. The cloud storage bucket 32 may be a virtual container within a cloud storage service that store digital files. For example, the cloud storage bucket 32 can store files generated by the ITOM 30 and can be implemented as S3 buckets or with buckets from another cloud storage service.

An engine 14 running the ITOM job transfers data from the ITOM cloud storage bucket to a staging database 34 for the enterprise. The engine 14 running the ITOM job instance may use an ETL (extract-transform-load) sync to transfer the data from the ITOM cloud storage bucket 30 to the staging database 34, for example, or the ITOM job instance could download the data in a CSV format. The engine 14 may then transfer the ITOM data to a raw database 36, and then update an active database 38 with active ITOM data (e.g., active ITOM incidents), according to a process described below, for use by the enterprise.

In various embodiments, the files generated by the ITOM 30 can comprise: (i) an activities file that stores single actions that a user has been doing; (ii) a change relations activities file that stores changes that have been marked as matched or not matched to an incident; (iii) a changes file that stores changes that have been sent to and processed by the ITOM 30; (iv) a change tags file that stores the tags associated with a single change in the ITOM (v) an entities file that stores single aggregated alerts in the ITOM 30 (e.g., a row in the ITOM timeline view); (vi) an events file that stores status changes for a single raw event in the ITOM 30; (vii) a incidents file that stores ITOM incidents; (viii) an incident tags file that stores the incident tags associated with ITOM incidents; (ix) a maintenance events file that stores events that are matched to ITOM maintenance plans; (x) a maintenance plans file that stores ITOM maintenance plans; (xi) a matchers log file that stores correlation patterns that matched and applied to a single ITOM incident; (xii) a RCC related changes file that stores single changes suspected as a potential room cause by the ITOM algorithm for single incidents; (xiii) a tags file that stores single tags for an entity; and/or (xiv) a user file that stores single users.

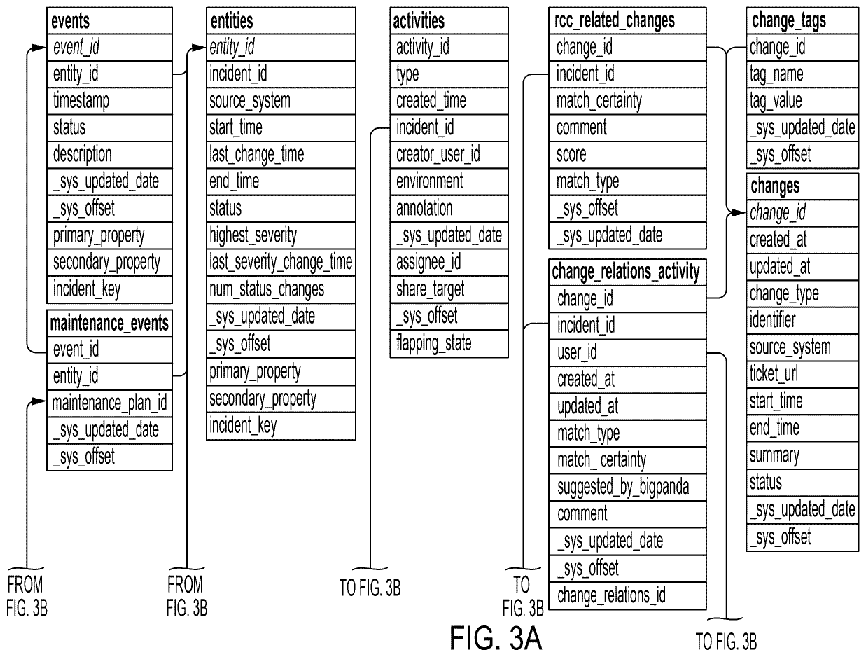

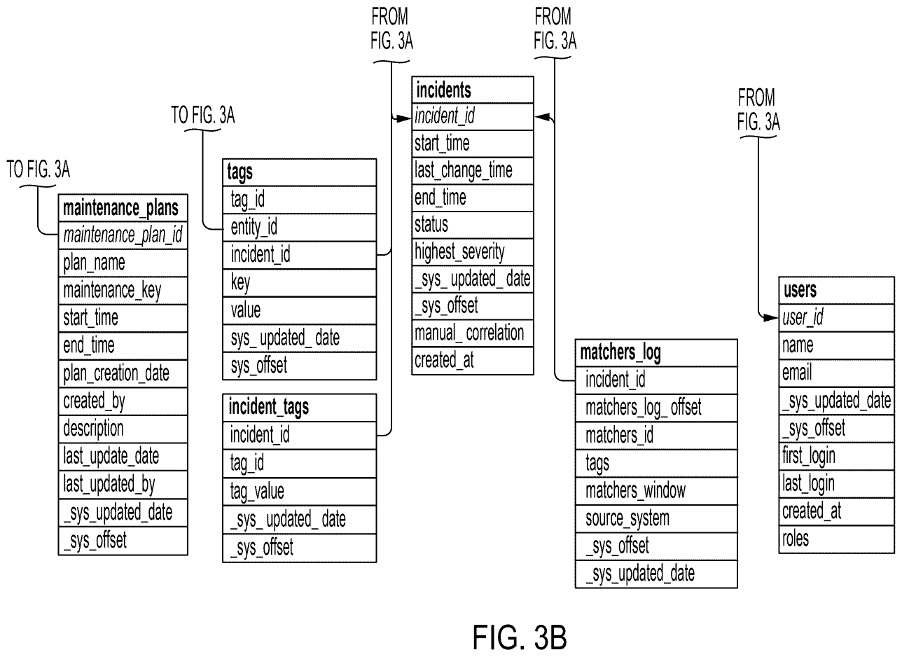

FIGS. 3A-B show a schema for the ITOM data stored in the ITOM cloud storage bucket 32. As shown in FIGS. 3A-B, each file can have a “_sys_offset” attribute, which is a system level timestamp for the file indicating a timestamp, for example, when an IT incident was ingested into the ITOM system 30.

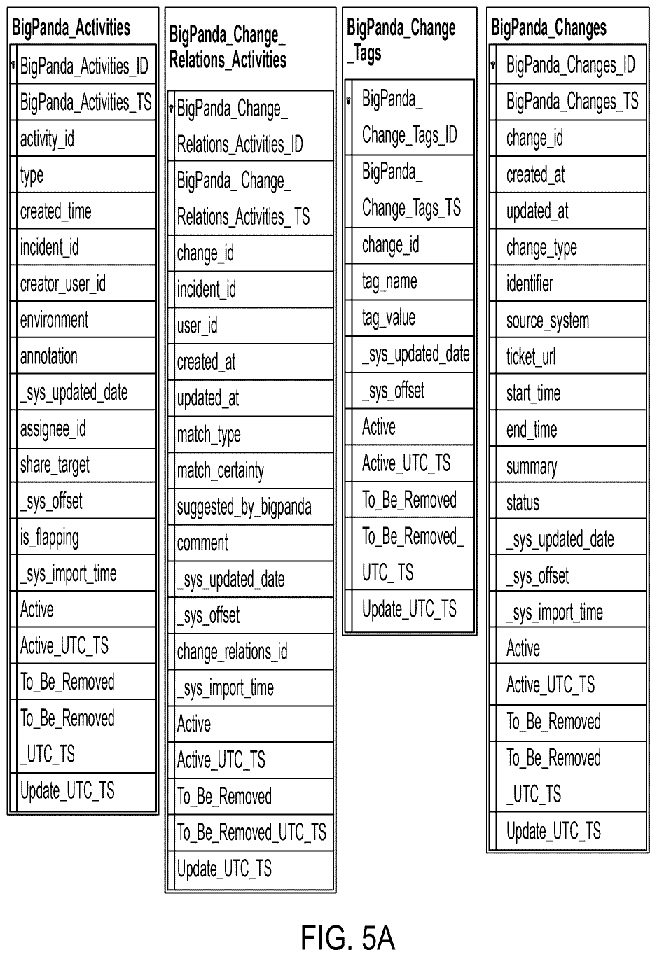

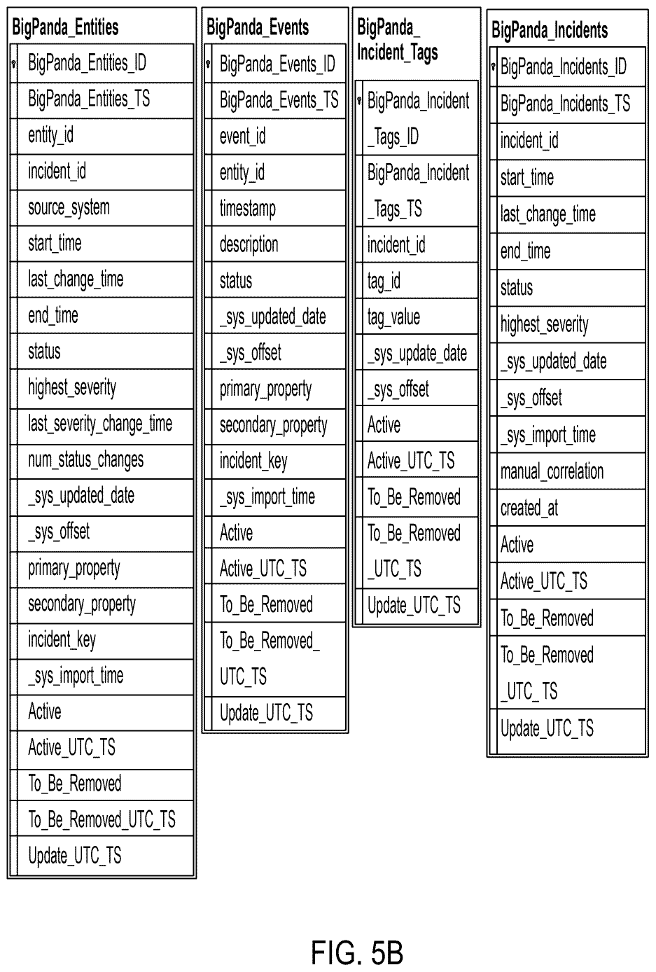

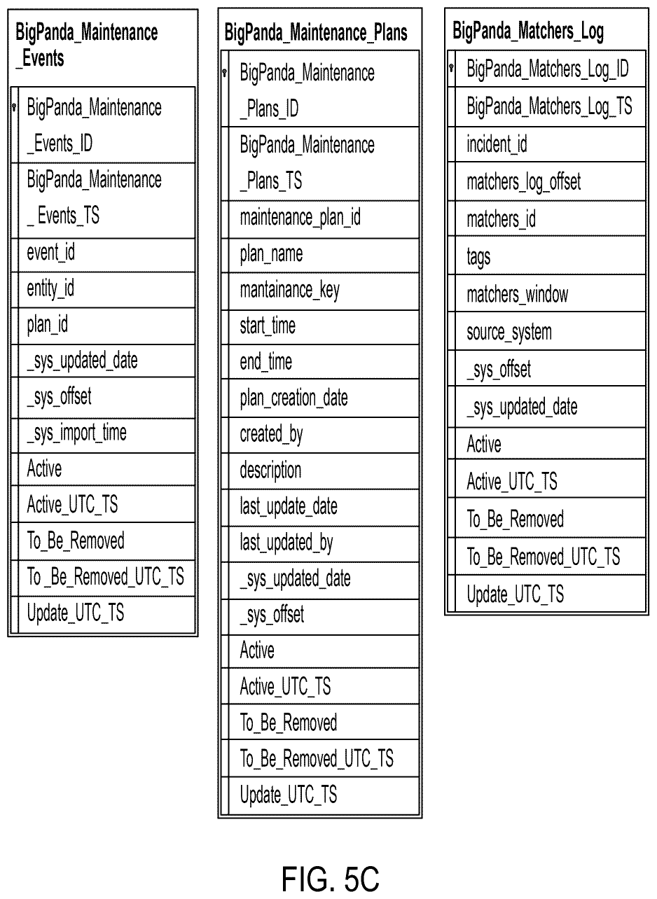

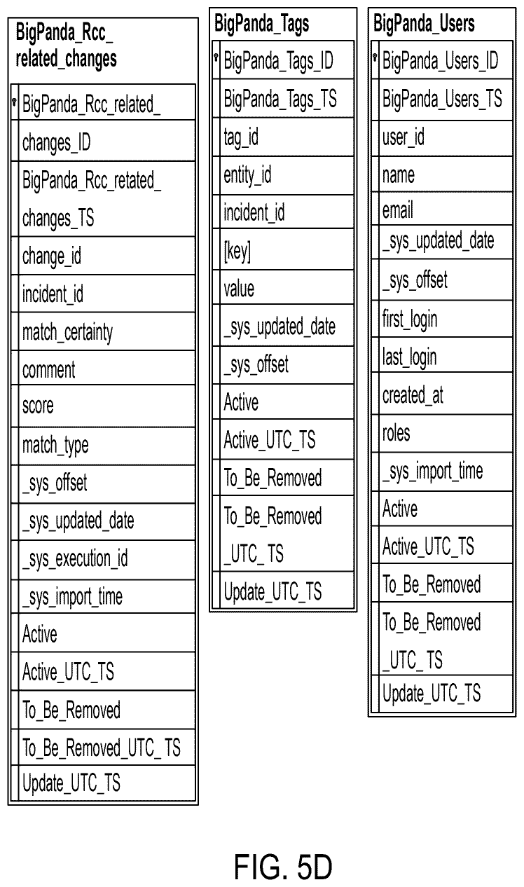

The staging database 34, the raw database 36 and the active 38 database may be implemental as SQL databases for example, hosted by respective SQL servers, such as, for example, Microsoft SQL servers. The databases 34, 36, 38 may store the ITOM data according to a key-value format, such as shown in FIGS. 5A-D, which shows how ITOM tables (in this example, BigPanda) might be imported through a ETL process. Every table that has gone through a ETL process stands by itself. The key value for a table can be determined based on values found from table. For example, with reference to the Tags Table in FIG. 5D, “BigPanda_Tags_ID” can be current key value, which can be determined based on “_sys_updated_date”, which can be a numerical instance of a point in time (e.g., Epoch time). If there is more than one value, then the “_sys_offset” value can used, with the maximum value thereof being used for the current record. The engine 14 running the ITOM job instance can use event IDs in the raw and active databases 36, 38 to determine what ITOM incidents are active at scale, e.g., determine active incidents as rapidly as incident data from the ITOM 30 is extracted from the ITOM cloud storage bucket 32. The staging database 34 may be used as a temporary storage area to hold the ITOM data before it is moved to raw database 36 for analysis by the ITOM job instance and updating of the active database 38. And the staging database 34 can continuously extract, transform, and load the ITOM data from the ITOM cloud storage bucket 32 as frequently the ITOM job is run by the engines 14.

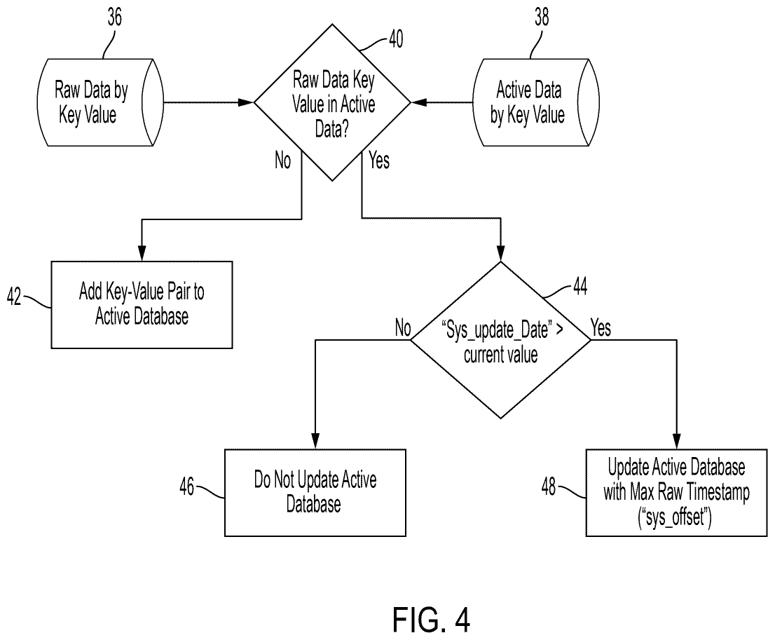

An exemplary process by which an instance of an engine 14 running the ITOM job updates the active database 38 with active ITOM data from the raw database 36, according to various embodiments of the present invention, is depicted in FIG. 4. At step 40, using the keys (e.g., event IDs) in the key-value pairs in the raw and active databases 36, 38, the engine 14 determines if each key in the raw database 36 is present in the active database 38. If a key is not present, the engine 14 can add the key-value from the raw database 36 to the active database 38.

If a key is present in the active database 38, at step 44, the engine 14 compares the timestamp for the last modification or updated (e.g., “_sys_update_date”) from the key-value pair in the raw database 36 to the corresponding timestamp (e.g., “_sys_update_date”) for the key-value pair in the active database 38. If the raw timestamp is not greater than the active timestamp, the engine does not, at step 46, update the active database 38 with data from the raw database 36 for that key. On the other hand, if the raw timestamp is greater than the active timestamp, the engine 14, at step 48, uses can use the maximum value found in the time offset attribute (e.g., “sys_offset”) to update the key-value pair in the active database 38. Step 48 can therefore also involve deleting the then-present timestamp in the active database 38 for the key; and then adding the maximum timestamp from the raw database 38 for that key in the active database 38. In this way, the active database 38 can be continually updated to reflect the latest active incident data from the ITOM 30. The enterprise can use the data in the active database, for example, to identify, prioritize, and address incidents; make capacity planning decisions (e.g., scaling infrastructure resources); and/or document their response processes for regulatory compliance and audits. Also, any data in the active database that is old can be marked for deletion and deleted by a job that is set to delete an data that is marked for deletion. Such a deletion job may be executed by an engine 14 in the same manner as other jobs performed by the engines, thereby integrating deletion operations into the job execution framework of the system.

In one general aspect, therefore, the present invention is directed to computer-implemented methods and systems for updating an active database with information technology operations management (ITOM) data from IT infrastructure of an enterprise. In one embodiment, the method includes: step (a), by an ITOM platform configured with collectors for enterprise IT infrastructure, collecting ITOM data, including at least one of incident data, alert data, or tag data, from the IT infrastructure and storing the ITOM data in a cloud storage bucket; step (b), by a first engine executed on a first server of a plurality of servers, loading the ITOM data from the cloud storage bucket to a staging database of an enterprise; step (c), by the first engine, loading the ITOM data from the staging database to a raw database, the raw database storing the ITOM data in a key-value format that includes, for each record, a system-generated update timestamp and a system offset attribute; step (d) by an instance of a second engine, the instance selected from a plurality of engines distributed across the plurality of servers and scheduled to run in a non-overlapping manner, determining whether to update an active database of the enterprise with data from the raw database. The determining step of step (d) can comprise: for a first key-value pair in the raw database having a key not present in the active database, inserting the first key-value pair into the active database; and for a second key-value pair in the raw database having a key present in the active database, comparing the system-generated update timestamp in the raw database to a corresponding update timestamp in the active database, and upon determining that the system-generated update timestamp in the raw database is later than the corresponding update timestamp in the active database, updating the active database with the second key-value pair using a maximum value of the system offset attribute from the raw database. The method can also comprise repeating steps (a)-(d) according to a schedule determined by a task scheduling server.

A computer system according the present invention can comprise an ITOM platform configured to collect ITOM data from the IT infrastructure, the ITOM data comprising at least one of incident data, alert data, or tag data, from the IT infrastructure and to store the ITOM data in a cloud storage bucket. The system can also comprise a plurality of servers, each comprising at least one processor and memory storing instructions, where a first server of the plurality of servers is configured to cause a first engine running on the first server to: load the ITOM data from the cloud storage bucket to a staging database of the enterprise; and load the ITOM data from the staging database to a raw database, the raw database storing the ITOM data in a key-value format that includes, for each record, a system-generated update timestamp and a system offset attribute. One of the plurality of servers is also configured to cause a second engine selected from a plurality of engines distributed across the plurality of servers and scheduled to run in a non-overlapping manner to determine whether to update an active database of the enterprise with data from the raw database. The determination can be made by: for a first key-value pair in the raw database having a key not present in the active database, inserting the first key-value pair into the active database; and for a second key-value pair in the raw database having a key present in the active database, comparing the system-generated update timestamp in the raw database to a corresponding update timestamp in the active database, and upon determining that the system-generated update timestamp in the raw database is later than the corresponding update timestamp in the active database, updating the active database with the second key-value pair using a maximum value of the system offset attribute from the raw database. The system also comprises a task scheduling server configured to determine a schedule according to which steps of collecting, loading, and determining are repeated.

In various implementations, the staging database, the raw database, and the active database are each implemented as SQL databases hosted by respective SQL servers.

In various implementations, the key-value format for the raw database and the active database includes, for each record, an automatically generated update timestamp attribute indicative of a last modification time and an automatically generated offset attribute indicative of an ingestion order, the offset attribute being usable to resolve conflicts among multiple records for a given key. In some embodiments, the update timestamp attribute may be called _sys_update_date, sys_updated_on, or another equivalent field name. Similarly, the offset attribute may be called _sys_offset, sequence_number, or another equivalent field name.

In some implementations, the active database is updated to reflect a current state of ITOM incidents based on updates from the raw database.

In various implementations, the plurality of engines are single-threaded engines each executing one job script at a time.

In various implementations, the instance of the engine is selected by the task scheduling server from among the plurality of engines distributed across the plurality of servers.

In various implementations, the task scheduling server determines schedules for the plurality of engines based at least in part on one or more parameters selected from the group consisting of: a period for a job, an expected runtime, a spread quantifier of runtime, a no-earlier-than start time, and a no-later-than start time.

In various implementations, the ITOM data stored in the cloud storage bucket comprises at least one file selected from the group consisting of: an activities file, a change relations file, a changes file, a change tags file, an entities file, an events file, an incidents file, an incident tags file, a maintenance events file, a maintenance plans file, a matchers log file, a related changes file, a tags file, and a user file.

In various implementations, updating the active database with the second key-value pair comprises deleting an existing timestamp for the second key-value pair in the active database and replacing it with a maximum value of the system offset attribute from the raw database.

In various implementations, the plurality of servers are distributed across multiple data centers.

In various implementations, the method is repeated at intervals of at least five minutes.

In various implementations, the method further comprises the step of marking stale data in the active database for deletion and deleting the stale data by an instance of an engine executing a deletion job.

The ITOM platform may include a software system or service that collects, aggregates, and manages data relating to the operation of enterprise information technology resources. In some implementations, the ITOM platform may be deployed on dedicated computing hardware. For example, the ITOM platform may execute on one or more servers, which each include at least one processor, memory, persistent storage, and network interfaces. The processor(s) may comprise central processing units (CPUs), graphics processing units (GPUs), or specialized accelerators configured to perform log ingestion, anomaly detection, or event correlation operations. The memory may include volatile memory such as DRAM as well as non-volatile memory such as flash or solid-state storage. The persistent storage may comprise local disks, network-attached storage, or distributed object storage systems. The network interfaces may include wired Ethernet adapters or wireless transceivers to communicate with monitored IT infrastructure components and with cloud storage services. In some cases, the ITOM platform may be embodied as a cluster of such servers operating in a cloud environment, with workload distribution managed by container orchestration software such as Kubernetes. In other embodiments, the ITOM platform may be provided as a virtual appliance, instantiated on hypervisors that execute on physical host machines within an enterprise data center. Examples of ITOM platforms include systems commercially available from ServiceNow, BigPanda, Splunk, or similar providers.

The ITOM data collected by such platforms may include, without limitation, incident records, alert events, change tickets, system logs, tags, configuration details, or other records that describe the status, performance, or changes of IT resources. The IT infrastructure may comprise computing, networking, and storage resources of an enterprise, such as servers, virtual machines, databases, middleware, networks, applications, and associated hardware and software components that are monitored or managed by the ITOM platform.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein. In addition, features described in connection with one embodiment may be combined with features of other embodiments, even if not explicitly shown or described, unless otherwise noted as mutually exclusive. Accordingly, the scope of the present invention should be construed broadly, consistent with the appended claims and their legal equivalents, rather than limited to the specific examples described.

What is claimed is:

1. A computer-implemented method for updating an active database with information technology operations management (ITOM) data from IT infrastructure of an enterprise, the method comprising:
(a) by an ITOM platform configured with collectors for enterprise IT infrastructure, collecting ITOM data, including at least one of incident data, alert data, or tag data, from the IT infrastructure and storing the ITOM data in a cloud storage bucket;
(b) by a first engine executed on a first server of a plurality of servers, loading the ITOM data from the cloud storage bucket to a staging database of an enterprise;
(c) by the first engine, loading the ITOM data from the staging database to a raw database, the raw database storing the ITOM data in a key-value format that includes, for each record, a system-generated update timestamp and a system offset attribute;
(d) by an instance of a second engine, the instance selected from a plurality of engines distributed across the plurality of servers and scheduled to run in a non-overlapping manner, determining whether to update an active database of the enterprise with data from the raw database, the determining comprising:
for a first key-value pair in the raw database having a key not present in the active database, inserting the first key-value pair into the active database; and
for a second key-value pair in the raw database having a key present in the active database, comparing the system-generated update timestamp in the raw database to a corresponding update timestamp in the active database, and upon determining that the system-generated update timestamp in the raw database is later than the corresponding update timestamp in the active database, updating the active database with the second key-value pair using a maximum value of the system offset attribute from the raw database; and
(e) repeating steps (a)-(d) according to a schedule determined by a task scheduling server.

2. The method of claim 1, wherein the staging database, the raw database, and the active database are each implemented as SQL databases hosted by respective SQL servers.

3. The method of claim 1, wherein the key-value format for the raw database and the active database includes, for each record, an automatically generated update timestamp attribute indicative of a last modification time and an automatically generated offset attribute indicative of an ingestion order, the offset attribute being usable to resolve conflicts among multiple records for a given key.

4. The method of claim 1, wherein the active database is updated to reflect a current state of ITOM incidents based on updates from the raw database.

5. The method of claim 1, wherein the plurality of engines are single-threaded engines each executing one job script at a time.

6. The method of claim 1, wherein the instance of the engine is selected by the task scheduling server from among the plurality of engines distributed across the plurality of servers.

7. The method of claim 1, wherein the task scheduling server determines schedules for the plurality of engines based at least in part on one or more parameters selected from the group consisting of: a period for a job, an expected runtime, a spread quantifier of runtime, a no-earlier-than start time, and a no-later-than start time.

8. The method of claim 1, wherein the ITOM data stored in the cloud storage bucket comprises at least one file selected from the group consisting of: an activities file, a change relations file, a changes file, a change tags file, an entities file, an events file, an incidents file, an incident tags file, a maintenance events file, a maintenance plans file, a matchers log file, a related changes file, a tags file, and a user file.

9. The method of claim 1, wherein updating the active database with the second key-value pair comprises deleting an existing timestamp for the second key-value pair in the active database and replacing it with a maximum value of the system offset attribute from the raw database.

10. The method of claim 1, wherein the plurality of servers are distributed across multiple data centers.

11. The method of claim 1, wherein repeating steps (a)-(d) according to the schedule comprises executing the method at intervals of at least five minutes.

12. The method of claim 1, further comprising marking stale data in the active database for deletion and deleting the stale data by an instance of an engine executing a deletion job.

13. A computer system for updating an active database with information technology operations management (ITOM) data from IT infrastructure of an enterprise, the system comprising:
an ITOM platform configured to collect ITOM data from the IT infrastructure, the IOTM data comprising at least one of incident data, alert data, or tag data, from the IT infrastructure and to store the ITOM data in a cloud storage bucket;
a plurality of servers, each comprising at least one processor and memory storing instructions, wherein:
a first server of the plurality of servers is configured to cause a first engine running on the first server to:
load the ITOM data from the cloud storage bucket to a staging database of the enterprise; and
load the ITOM data from the staging database to a raw database, the raw database storing the ITOM data in a key-value format that includes, for each record, a system-generated update timestamp and a system offset attribute;
one of the plurality of servers is configured to cause a second engine selected from a plurality of engines distributed across the plurality of servers and scheduled to run in a non-overlapping manner to determine whether to update an active database of the enterprise with data from the raw database, the determination comprising:
for a first key-value pair in the raw database having a key not present in the active database, inserting the first key-value pair into the active database; and
for a second key-value pair in the raw database having a key present in the active database, comparing the system-generated update timestamp in the raw database to a corresponding update timestamp in the active database, and upon determining that the system-generated update timestamp in the raw database is later than the corresponding update timestamp in the active database, updating the active database with the second key-value pair using a maximum value of the system offset attribute from the raw database; and
a task scheduling server configured to determine a schedule according to which steps of collecting, loading, and determining are repeated.

14. The system of claim 13, wherein the staging database, the raw database, and the active database are each implemented as SQL databases hosted by respective SQL servers.

15. The system of claim 13, wherein the key-value format for the raw database and the active database includes, for each record, an automatically generated update timestamp attribute indicative of a last modification time and an automatically generated offset attribute indicative of an ingestion order, the offset attribute being usable to resolve conflicts among multiple records for a given key.

16. The system of claim 13, wherein the active database is updated to reflect a current state of ITOM incidents based on updates from the raw database.

17. The system of claim 13, wherein the plurality of engines are single-threaded engines each executing one job script at a time.

18. The system of claim 13, wherein the plurality of servers are distributed across multiple data centers.

19. The system of claim 13, wherein the memories of the plurality of servers further comprise instructions stored that, when executed by one of the plurality of servers, cause an engine to mark stale data in the active database for deletion and to execute a deletion job that deletes the stale data.
